(19) United States
(12) Patent Application Publication
(10) Pub. No.: US 2011/0064565 A1
(43) Pub. Date: Mar. 17, 2011

(54) HARNESS CABLE

(75) Inventor: Gareth L. Jones, Caldicot (GB)

(73) Assignee: ROLLS-ROYCE PLC, London (GB)

(21) Appl. No.: 12/992,624

(22) PCT Filed: May 18, 2009
(86) PCT No.: PCT/GB09/01243

§ 371 Date: Nov. 15, 2010

(30) Foreign Application Priority Data
Jun. 6, 2008 (GB) 0810345.9

(51) Int. Cl. F03B 13/00; H01B 7/06; G02B 6/44; G02B 6/46; F16L 55/027

(52) U.S. Cl. 415/121.3; 174/69; 385/100; 385/136; 138/42

(57) ABSTRACT

A conduit assembly for the communication of electricity, light or fluid, including at least one conduit, wherein the conduit assembly also includes a core member, the at least one conduit in contact with the core member and arranged in a convoluted path defined with respect to the shape of the core mernber, the at least one conduit thereby having a first direct length between its ends such that removal of at least a portion of the core member permits the at least one conduit to straighten in the region of the core member removal to increase its direct length to a second direct length, the second direct length being greater than the sum of the first direct length and the length removed from the core member.

The present invention relates to a conduit assembly and is particularly suited to a cable forming part of an electrical harness for an engine, especially a gas turbine engine.

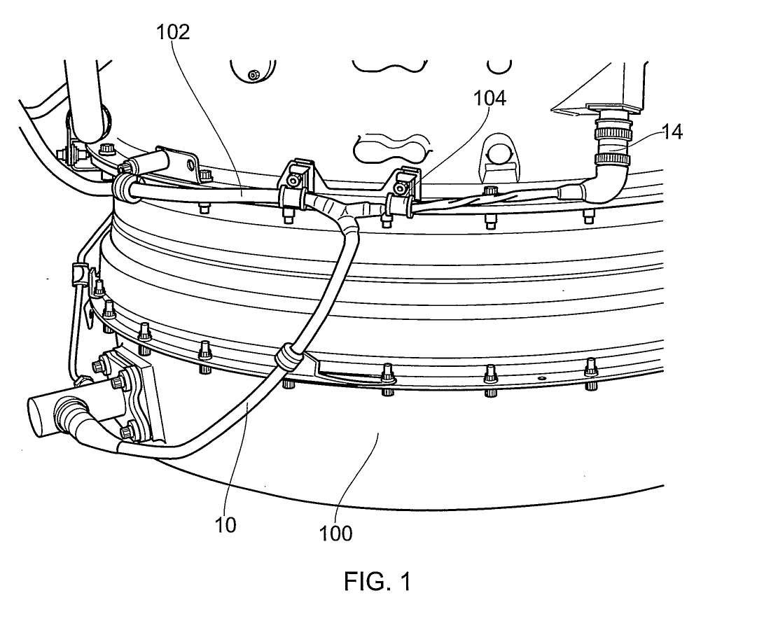

FIG. 1 shows part of the outside of a fan casing and intercase of a gas turbine engine 100. The external surface of a gas turbine engine 100 hosts accessories such as an external gearbox, oil supply and pump, and electronic controller along with a variety of fluid lines and electrical distribution arrangements interconnecting these and internal features of the engine. In particular, the electrical and electronic wires are bundled together to form cables 10 that are routed around the engine as an electrical harness 102. One such harness 102 is shaded on FIG. 1. The harness 102 is attached to the engine 100 at various attachment points 104. Advantageously, such attachment points 104 can also comprise an earth connection to the engine 100. The harness 102 is arranged so that there is little or no slack between attachment points 104 as this reduces the likelihood of catching and damaging the cables 10 during fitting of other components to the engine 100 or during maintenance. A small amount of slackness may be retained to allow for thermal expansion of the engine 100 during service. There is likely to be a necessity for connectors 14 within the cable 10 runs comprising the harness 102. These may be required where a single length of cable 10 is not long enough or where one or more cable 10 need to branch in multiple directions, or where the cable 10 connects to an accessory.

Such connectors 14 enable the wires to be joined together within a protected environment. However, in service the wires within a connector 14 can become worn or damaged by the relative movement of the wire within the connector 14, as described more fully in the following paragraph, or by heating or otherwise. Alternatively, the connector 14 itself may become damaged and need replacing. It is required that the connections within the connectors 14 must be capable of being repaired a number of times, for example three times, before a new harness 102 or part of a harness 102 need be considered. To repair the connections requires the connector 14 to be opened and the wires cut adjacent to the faulty section. The shortened wires can then be reconnected to the terminals within the connector 14, which is then closed. This requires a length of excess wire to be incorporated in the cables 10 or connectors 14 when first installed to allow for the subsequent shortening in service. Since the cables 10 comprise little or no slack between attachment points 104 there is no potential to store the excess wire as excess cable 10. Thus, other storage arrangements are required.

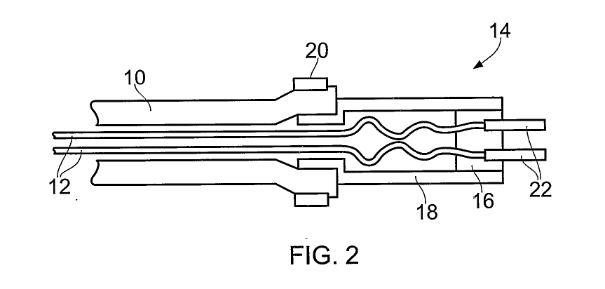

A prior arrangement of harness cable and connector is shown in FIG. 2 and comprises a cable 10 through which runs a pair of wires 12. A connector 14, comprising a connection portion 16 and a backshell 18, is connected to the cable 10 by suitable clamping means 20. The wires 12 terminate in, or are connected to, connection pins 22. Whilst encased in the cable 10, the wires 12 are substantially coaxial thereto. In the backshell 18, however, the wires 12 take an unguided, tortuous path until connected to the connection pins 22 so that an amount of slackness is incorporated in the hollow backshell 18. In the event that the connector 14, or part thereof, needs to be replaced or repaired the wires 12 are cut immediately adjacent the connector pins 22 (or the damaged section if applicable) and the connection remade by taking up some of the slack of the wires 12 residing in the backshell 18.

One disadvantage of this arrangement is that the slack wire 12 located in the connector backshell 18 has a tendency to fret or chafe against the interior surfaces of the backshell 18, potentially wearing through the coating of the wires 12 and leading to electrical shorting. This can be partially alleviated by applying an anti-fretting coating to the interior surfaces. However, it is difficult to apply this evenly and completely so that the problem remains.

It would thus be advantageous to have a repairable cable and connector arrangement for an electrical harness that alleviates or, more preferably, removes the problems associated with the prior arrangement.

Accordingly the present invention provides a conduit assembly for the communication of electricity, light or fluid comprising at least one conduit, characterised in that the conduit assembly further comprises a core member, the at least one conduit in contact with the core member and arranged in a convoluted path defined with respect to the shape of the core member, the at least one conduit thereby having a first direct length between its ends such that removal of at least a portion of the core member permits the at least one conduit to straighten in the region of the core member to increase its direct length to a second direct length, the second direct length being greater than the sum of the first direct length and the length removed from the core member.

The core member may comprise at least one protrusion of greater diameter than the rest of the core member. Preferably the at least one protrusion may be circular, elliptical or diamond-shaped in cross-section.

The convoluted path described by the at least one conduit may circumnavigate the core member. The at least one conduit may be helically wound around the core member. The core member may comprise at least one groove for receiving the at least one conduit. Preferably the at least one groove is helical.

Preferably the core member is cylindrical and/or flexible.

The conduit assembly may comprise a cable and the at least one conduit comprise an electrical wire. Alternatively the at least one conduit may comprise an optical fibre or a tube.

A second aspect of the present invention provides a harness assembly for a component comprising a plurality of conduit assemblies wherein the conduit assemblies are connectable to each other at their respective ends and are connectable to the component at fixed locations corresponding to the length of the conduit assembly.

A third aspect of the present invention provides a gas turbine engine comprising a harness assembly.

The present invention will be more fully described by way of example with reference to the accompanying drawings, in which:

FIG. 1 is a schematic perspective view of part of a gas turbine engine including a harness arrangement as described above.

FIG. 2 is a sectional side view of a prior art cable and connector as described above.

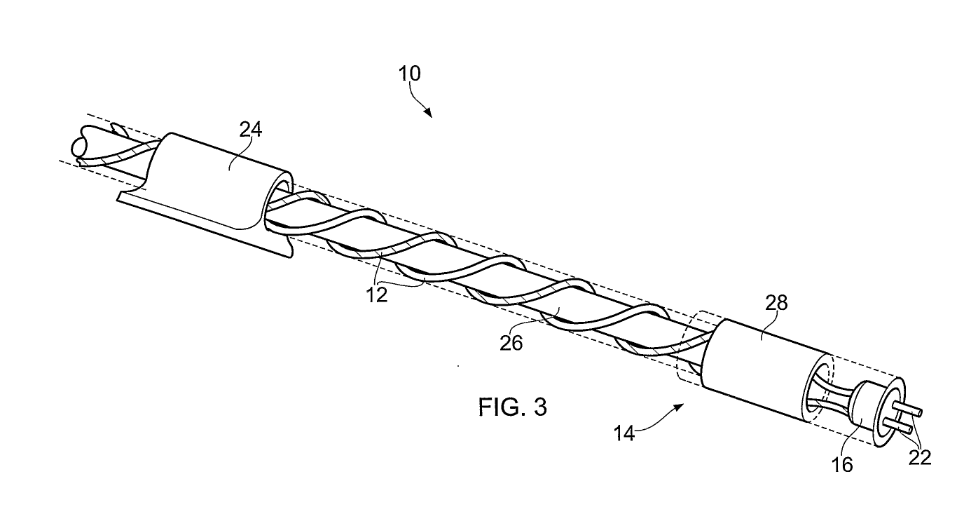

FIG. 3 is a perspective view, partially in section, of a main embodiment of a cable and connector according to the present invention.

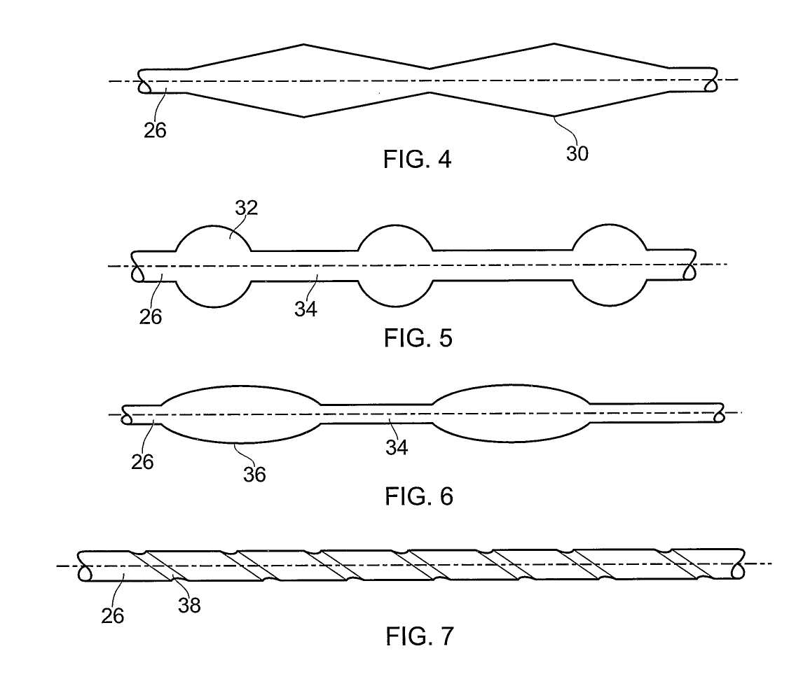

FIGS. 4 to 7 are sectional side views of alternative embodiments of a core member of the cable according to the present invention.

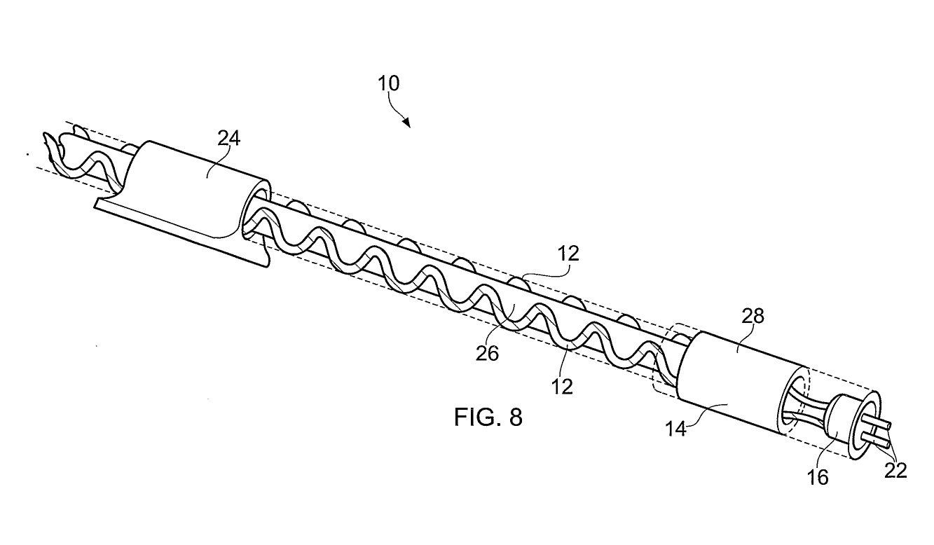

FIG. 8 is a perspective view, partially in section, of an alternative embodiment of a cable and connector according to the present invention.

An exemplary embodiment of the present invention is shown in FIG. 3. Although the present invention can be any conduit assembly comprising conduits, a specific embodiment is described herein as an electrical cable comprising wires. A cable 10 is shown comprising an outer sheath 24, mainly indicated by broken lines for clarity. The sheath 24 comprises a flexible protective material such as Viton® or PEEK (polyetheretherketone). A connector 14 is located at one end of the cable 10 and comprises a connection portion 16 having two connection pins 22 extending longitudinally therefrom for engagement with another connector 14 or a component of the gas turbine engine 100. There are two insulated wires 12 extending through the outer sheath 24 and connected one to each of the two connection pins 22.

The cable 10 further comprises a central core member 26 that is cylindrical and extends longitudinally through the central bore of the outer sheath 24. The diameter of the core member 26 is smaller than the internal diameter of the sheath 24 by a sufficient amount to enable the outer sheath 24 to hold the wires 12 in contact with the core member 26 without excessive pressure being applied thereto. The wires 12 follow a convoluted path in relation to the core member 26 by being wound in a helical or spiral pattern around the core member 26. As illustrated, two wires 12 are wound so that they do not cross each other or their own adjacent loops. This provides a more uniform profile to the cable 10 and reduces the opportunities for friction between the wires 12 and the resultant likelihood of chafing causing a flaw in the wire coating leading to electrical shorting. Advantageously the core member 26 is dimensioned such that the gap between the core member 26 and the inside of the outer sheath 24 is substantially the same as the diameter of the wires 12 passing through the cable 10 so that the wires 12 are in contact with both the core member 26 and the outer sheath 24. This allows the wires 12 to be lightly constrained in the designated helical path so that they do not move during operation of the gas turbine engine 100, but does not exert a pressure on the wires 12 sufficient to damage them.

Each wire 12 has an actual length, defined as the total length from end to end and can be thought of as the length of each wire 12 when laid out in a straight line. It is the same as the length of the convoluted path followed by the wire 12 within the cable 10. Each wire 12 also has a direct length, which is the shortest, straight-line distance between the ends of each wire 12, presuming that the cable 10 in which the wires 12 are bundled is straight and not curved. Since the wires 12 are constrained to follow a convoluted path within the cable 10, it will be appreciated that each wire 12 has a length greater than the length of the cable 10. Initially, the direct length from end to end of the cable 10 is the same as the length of the core member 26 but, as will be explained below, this is not always the case.

The core member 26 is preferably a relatively flexible, somewhat malleable material such as PTFE or Nomex® so that none of the flexibility of the prior art cable 10 is lost. However, there may be some benefit to the increased stiffness of the cable 10 comprising the core member 26 in terms of the cable 10 maintaining its shape and positioning when fitted to a gas turbine engine 100. This may result in fewer attachment points 104 being required which reduces the component weight. The amount of stiffening versus the flexibility required is a matter for design and as such does not limit the scope of the invention herein described.

In order to connect a cable 10, as described, to a connector 14 it is necessary to expose a portion of the wires 12. As is well known in the art of electrical connection, it is then necessary to strip back a length of the coating/insulation of the wire 12 to expose the bare conductor, usually metal, which is then attached to the connection pins 22 of the connector 14 by any suitable means such as soldering, crimping or screws. The precise method of connection is immaterial and as such any form of connection may be used in conjunction with the arrangement of the present invention. To expose a length of the wires 12, the outer sheath 24 is peeled back to reveal the inner components. The wires 12 are unwound from the core member 26, which is then cut a suitable distance from the location of the desired connection and the end portion removed. The wires 12 are then connected to the connection portion 16 and the sheath 24 returned to its normal position. Optionally, there may be an additional sheath 28 fitted around the outside of the outer sheath 24 of the cable 10 to improve the insulation around the connector 14 and/or cover the connector 14 and the second connector or connection point on a component to which it is connected.

In the end portion of the cable 10 where the core member 26 has been removed, the wires 12 are no longer constrained to the helical path followed in the rest of the cable 10. This means that the wires 12 will naturally be able to assume a more direct path between the end of the core member 26 and the connection pins 22. Hence, for the same length of outer sheath 24 the wires 12 can extend further and therefore reach and be connected to the connection pins 22 of the connector 14. This reduces waste since the cable 10 does not need to be oversized and then have a portion of the outer sheath 24 removed during fitting.

This arrangement has additional benefits when a repair is required. Where fitted, the additional sheath 28 is removed. The outer sheath 24 is peeled back to reveal the internal components and the connection pins 22 are disconnected. Damaged wire 12 is removed, thereby shortening the length of wire 12 available for reconnection. Therefore, to remake the connection at substantially the same location, a further end portion of the core member 26 is cut away so that the wires 12 can take a direct path rather than the helical path around the core member 24 for this portion of the cable 10. As for initial connection, the wires 12 are then connected to the connection pins 22 in the connection portion 16 of the connector 14 and then the outer sheath 24 (and additional sheath 28 if used) refitted. This means that the overall length of the cable 10 remains constant but repairs involving removal of lengths of wire 12 can be effected as required. If a relatively long section of wire 12 is removed it can be compensated by removing the whole of the core member 26, although this removes some of the internal support offered by the core member 26 in normal operation.

There is a clear benefit to this arrangement in comparison to the prior art since there is no need for unconstrained slack wire 12 to be stored in a backshell 18 where it can chafe and become damaged. This also means that the connector 14 can be more compact since there is no need for a backshell 18, which further reduces complexity and weight.

FIGS. 4 to 7 show alternative embodiments of the core member 26, which can be used in some or all applications of the present invention. In FIG. 4 the core member 26 comprises at least one diamond cross-section protrusion 30. The protrusions 30 selectively increase the diameter of the core member 26 enabling more excess wire 12 to be stored than on the cylindrical core member 26 shown in FIG. 3. Preferably the protrusions are of a length such that a single protrusion is snapped off or otherwise removed when making a repair. The diameter of the protrusions 30 can also be adjusted to store the required amount of excess wire 12 so that only one protrusion 30 need be removed for each repair in normal circumstances. Although this arrangement has certain advantages over the first embodiment described with reference to FIG. 3, it may be unhelpful to have the widest diameter of the protrusion 30 comprising a point as illustrated since this may cause damage to the wires 12. However, the shape may be slightly modified to include a radiused or cylindrical portion at this outer extent.

FIG. 5 shows a similar arrangement to FIG. 4 in which the diamond cross-section protrusions 30 are exchanged for spherical protrusions 32 or beads. These are discrete in the sense that there is a cylindrical portion 34 of core member 26 between each protrusion 32. The spherical protrusions 32 overcome the pointed maximum diameter discussed above with reference to FIG. 4. However, care will be required in the sizing of the beads 32 so that helical coils of the wires 12 do not slip down one or both sides of the protrusions 32 either whilst forming the cable 10, and thereby providing less excess wire 12 than expected, or during use.

FIG. 6 shows a variant of the spherical protrusions 32 of FIG. 5 which overcome the abovementioned problem therewith. In this fourth embodiment of the core member 26, discrete ellipsoid protrusions 36 are provided between cylindrical portions 34 of the core member 26. This has the advantage of providing a smooth increase in the diameter of the core member 26 to enable extra excess wire 12 to be stored whilst providing a gentler contour so that the helical coils of the wires 12 do not slip against each other. As in the previous embodiments, the protrusions 36 can be proportioned so that a single one is removed to provide sufficient wire 12 for a repair.

A fifth embodiment of the core member 26 is shown in FIG. 7 in which a helical groove 38 is inscribed in the surface of the core member 26 to receive each wire 12 bundled in the cable 10. This enables the core member 26 to have a substantially equal diameter to the inside diameter of the outer sheath 24 of the cable 10, rather than the smaller diameter in the other embodiments described. Since the wires 12 are seated within the helical grooves 38, they are unable to move longitudinally, either during forming of the cable 10 or during use, thereby ensuring the length of wire 12 is known and that there is no opportunity for rubbing or chafing against the core member 26 or sheath 24 during use.

This embodiment has the further advantage that the core member 26 may be removed by an unscrewing motion. This means that there is no need to peel back the outer sheath 24 in order to expose the wires 12 and core member 26. Instead, the core member 26 is twisted or rotated around its longitudinal axis enabling the helical grooves 38 and wires 12 to move relative to each other like a screw and thread. Once a sufficient portion of the core member 26 protrudes clear of the outer sheath 24, it may be cut as before to shorten it.

The helical groove 38 of the fifth embodiment is shown on a cylindrical core member 26. However, it may also be used with any of the alternative embodiments of the core member 26 described with reference to FIGS. 4 to 6 in order to derive the benefits of providing both protrusions and grooves. Thus, in combination, the core member 26 enables excess wire 12 to be stored in a controlled manner that is reasonably well protected from damage (particularly from chafing or rubbing) and yet is easily accessible when effecting repairs to connections at the ends of the cable 10.

Although the present invention has been described with respect to two wires 12 wound on the core member 26, the benefits may be derived equally in applications requiring only one or more than two wires 12 in a cable 10 each connected to its own connection pin 22. The spacing of the helical coils of the wires 12 may be closer or more distant as appropriate, but preferably a small separation is retained to prevent crossing of adjacent coils if the cable 10 is bent in a tight radius in service, as illustrated in some portions of the electrical harness 102 shown in FIG. 1. As will be apparent to the skilled reader, closer coils enables more excess wire 12 to be stored on the same length core member 26 but some of the benefit of the present invention can be obtained by a relatively loose helical path.

Although the various embodiments of the core member 26 according to the present invention have been described as symmetrical in cross-section around a longitudinal axis of the cable 10, there may be advantages to an asymmetric configuration in certain situations, such as when the cable 10 is to be mounted very close to an adjacent component or in an otherwise restricted location. Additionally, although the described embodiments of the core member 26 are described as based on a cylindrical core or having cylindrical portions 34 between protrusions, other shaped core members 26 may be used. For example, a polygonal prism having three, four or more sides may be contemplated. It may be advantageous in this situation to provide a radius between faces to smooth the edges and therefore eliminate sharp edges that can damage the wires 12.

The cable 10 can be understood to be a bundle of conduits, being electrical wires 12. Alternatively the conduits of the cable 10 may comprise optical fibres. In a further variant, the conduit assembly comprises a pipe or tube having internal pipes or tubes, for example to transport one or more fluids.

Although the main embodiment of the present invention has been described as having at least one conduit, wire 12, wound around the core member 26 in a helical path, other arrangements are possible. For example, the convoluted paths followed by two or more conduits, wires 12, may be defined along a restricted portion of the core member 26. In particular, each of two wires 12 may follow a tortuous or convoluted path on one side of the core member 26 as shown in FIG. 8. As illustrated, two wires 12 follow approximately sinusoidal paths. However, other shaped paths are contemplated to fall within the scope of the present invention. As above, these alternative path shapes may be combined with the protrusions in FIGS. 4 to 6, discrete or continuous, and/or grooves similar to those in FIG. 7. The paths may also be defined with respect to a core member 26 of a different cross-sectional shape, for example a square, rectangular or other polygon. Where a plurality of conduits 12 are bundled in the assembly 10, it may be beneficial for the core member 26 to have the form of a polygonal prism with an equivalent number of faces to the number of conduits 12, e.g. a triangular-based prism where three conduits 12 are used, a hexagonal prism where six conduits 12 are used.

Although the invention has been described with an end portion of the core member 26 being removed to increase the available length of wire 12, equal felicity can be derived by removing a different portion of the wire 12, for example the middle of it. This may be more difficult in practical terms but can have additional benefits in that the strength and support is maintained in the end portions of the cable 10.

1. A conduit assembly for the communication of electricity, light or fluid, comprising at least one conduit, wherein the conduit assembly further comprises a core member, the at least one conduit in contact with the core member and arranged in a convoluted path defined with respect to the shape of the core member, the at least one conduit thereby having a first length between its ends such that removal of at least a portion of the core member permits the at least one conduit to straighten in the region of the core member removal to increase its length to a second length, the second length being greater than the sum of the first length and the length removed from the core member.

2. A conduit assembly as claimed in claim 1 wherein the core member comprises at least one protrusion of greater diameter than the rest of the core member.

3. A conduit assembly as claimed in claim 2 wherein the at least one protrusion is one of the group comprising circular, elliptical or diamond shaped in cross-section.

4. A conduit assembly as claimed in claim 1 wherein the convoluted path described by the at least one conduit circumnavigates the core member.

5. A conduit assembly as claimed in claim 4 wherein the at least one conduit is helically wound around the core member.

6. A conduit assembly as claimed in claim 1 wherein the core member comprises at least one groove for receiving the at least one conduit.

7. A conduit assembly as claimed in claim 6 wherein the at least one groove is helical.

8. A conduit assembly as claimed in claim 1 wherein the core member is cylindrical.

9. A conduit assembly as claimed in claim 1 wherein the core member is flexible.

10. A conduit assembly as claimed in claim 1 wherein the conduit assembly comprises a cable.

11. A conduit assembly as claimed in claim 10 wherein the at least one conduit comprises an electrical wire.

12. A conduit assembly as claimed in claim 10 wherein the at least one conduit comprises an optical fibre.

13. A conduit assembly as claimed in claim 1 wherein the at least one conduit is a tube.

14. A harness assembly for a component comprising a plurality of conduit assemblies as claimed in claim 1 wherein the conduit assemblies are connectable to each other at their respective ends and are connectable to the component at fixed locations corresponding to the length of the conduit assembly.

15. A gas turbine engine comprising a harness assembly as claimed in claim 14.
